(19) United States
(12) Patent Application Publication
(10) Pub. No.: US 2007/0228918 A1
(43) Pub. Date: Oct. 4, 2007

(54) Plasma display module

(76) Inventor: Tae-Kyoung Kang, Suwon-si (KR)

Correspondence Address: Robert E. Bushnell, Suite 300, 1522 K Street, N.W., Washington, DC, 20005, US

(21) Appl. No.: 11/727,356

(22) Filed: Mar. 26, 2007

(30) Foreign Application Priority Data
Mar. 31, 2006 (KR) 10-2006-0029719

(51) Int. Cl. H01J 1/18

(52) U.S. Cl. 313/269; 313/582

(57) ABSTRACT

A plasma display module that can reduce noise is provided. The plasma display module includes a plasma display panel (PDP) that displays images, a driving apparatus driving the plasma display panel, a chassis supporting the plasma display panel and the driving apparatus. The chassis is disposed between the plasma display panel and the driving apparatus. A vibration reduction unit is disposed on a portion of a non-display are of the plasma display panel. The vibration reduction unit effectively removes noises generated during the operation of the plasma display panel.

### CLAIM OF PRIORITY

This application makes reference to, incorporates the same herein, and claims all benefits accruing under 35 U.S.C. §119 from an application for PLASMA DISPLAY MODULE earlier filed in the Korean Intellectual Property Office on the 31 Mar. 2006 and there duly assigned Serial No. 10-2006-0029719.

### BACKGROUND OF THE INVENTION

1. Field of the Invention

The present invention relates to a plasma display module, and more particularly, to a plasma display module capable of reducing noise.

2. Description of the Related Art

Recently, plasma display panels (PDPs) are considered as next-generation displays replacing cathode ray tubes (CRTs). In the PDPs, a discharge gas is injected between two substrates, in which a plurality of electrodes are formed, and a discharge voltage is applied to the discharge gas to generate ultraviolet rays. The ultraviolet rays excite phosphor materials formed in predetermined patterns so as to generate visible light to form images.

A contemporary plasma display module includes a contemporary PDP, a driving apparatus including a circuit board, and a chassis. The contemporary PDP includes a front substrate and a rear substrate, a plurality of discharge electrodes, a dielectric layer covering the discharge electrodes, barrier ribs defining discharge cells, and a frit sealing the front and rear substrates with each other.

In the contemporary PDP, noise mainly generates from a non-display area located on edges of the PDP. FIG. 1 schematically shows portion A of a contemporary PDP that mainly generates noise, and FIG. 2 shows an inside of the contemporary PDP that includes outermost barrier rib 13 of barrier ribs of the contemporary PDP shown in FIG. 1.

Referring to FIGS. 1 and 2, portion A, which generates noises and vibrations, exists on edge portions of PDP 10 that includes front substrate 11 and rear substrate 12. The position of portion A is closely related to outermost barrier rib 13 (shown in FIG. 2). Outermost barrier rib 13 is a dummy barrier rib that extends into the non-display area. On other words, outermost barrier rib 13 is fabricated by forming a shape of the barrier rib on a substrate or dielectric layer 14 using a barrier rib material, and then baking the barrier rib material.

After the baking process, outermost barrier rib 13 shrinks producing contraction force 15 as shown in FIG. 2. When the contraction force 15 is produced in outermost barrier rib 13, a corner portion of outermost barrier rib 13 is more difficult to contract than other portions of outermost barrier rib 13, and thus, the corner portion of outermost barrier rib 13 peels off to balance under contraction force 15. Therefore, a protrusion is formed at the corner portion of outermost barrier rib 13 along a direction denoted by arrow 16, and a lower portion of the corner of outermost barrier rib 13 rises as denoted by arrow 17.

The protrusion at the corner of outermost barrier rib 13 causes collisions of outermost barrier rib 13 with front substrate 11, rear substrate 12, and dielectric layer 14, when shock waves are generated due to an internal discharge during the driving of PDP 10. The collisions produce noise and vibrations during the operation of PDP 10.

As described above, in the contemporary plasma display module, the noise generated at the edge of the PDP due to the thermal deformation of the barrier rib cannot be efficiently removed, and thus, durability and quality of the PDP degrade.

### SUMMARY OF THE INVENTION

The present invention provides a plasma display module capable of reducing noise.

According to an aspect of the present invention, there is provided a plasma display module including a plasma display panel for displaying an image, a driving apparatus for driving the plasma display panel, a chassis disposed between the second surface of the plasma display panel and the driving apparatus, and a vibration reduction unit disposed on the non-display area of the plasma display panel. The plasma display panel has a first surface and a second surface that is substantially parallel to the first surface, and the plasma display panel has a display area for displaying the image and a non-display area that does not display the image. The chassis is coupled to each of the plasma display panel and the driving apparatus.

The driving apparatus may include a plurality of circuit elements and a plurality of circuit boards on which the circuit elements are disposed.

The plasma display panel may be coupled to the chassis through a double sided adhesive unit.

The plasma display module may further include a heat dissipation sheet being disposed between the second surface of the plasma display panel and the chassis.

The vibration reduction unit may be disposed on the first surface of the plasma display panel. The vibration reduction unit may be disposed on the second surface of the plasma display panel. The vibration reduction unit may have a closed shape or an open shape. The vibration reduction unit may be formed to surround the display area of the plasma display panel. The vibration reduction unit may be disposed at a corner of the plasma display panel. The vibration reduction unit may include a tape.

The vibration reduction unit may have an adhesive surface. The vibration reduction may have a first adhesive surface and a second adhesive surface that is substantially parallel to the first adhesive surface. The first adhesive surface of the vibration reduction unit may be attached to the second surface of the plasma display panel, and the second adhesive surface of the vibration reduction unit may be attached to the chassis. The vibration reduction unit may be formed by applying a vibration-reduction material having a paste form. The vibration reduction unit may contact the chassis. The vibration reduction unit may be made of a material including silicon. The vibration reduction unit may be made of a material including polyurethane.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 shows portion A of a contemporary plasma display panel (PDP) that generates noise;

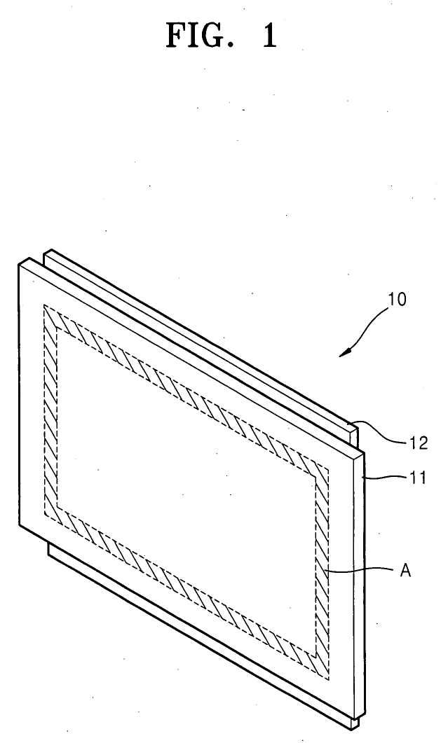

FIG. 2 is a schematic exploded perspective view of an outermost barrier rib built inside the PDP of FIG. 1;

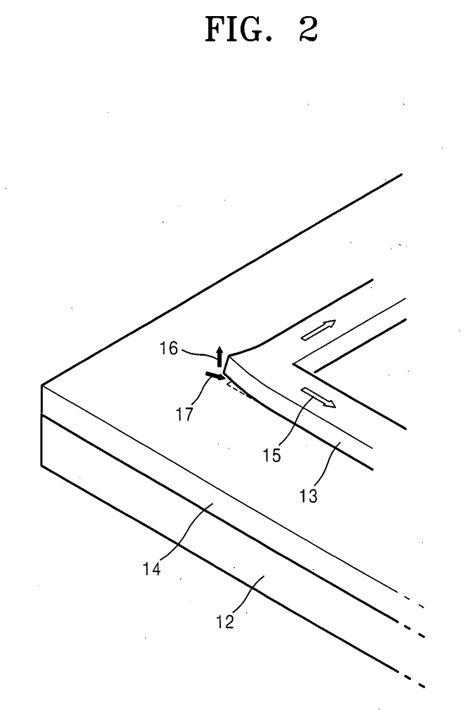

FIG. 3 is a schematic exploded perspective view of a plasma display module constructed as an embodiment of the present invention;

FIG. 4 is a front view of a PDP that is included in the plasma display module shown in FIG.3;

FIG. 5 is a partially cut perspective view of a display area of the PDP that is included in the plasma display module shown in FIG. 3; and

FIG. 6 is a schematic exploded perspective view of a plasma display module constructed as another embodiment of the present invention.

### DETAILED DESCRIPTION OF THE INVENTION

A plasma display module of the present invention will be described with reference to accompanying drawings.

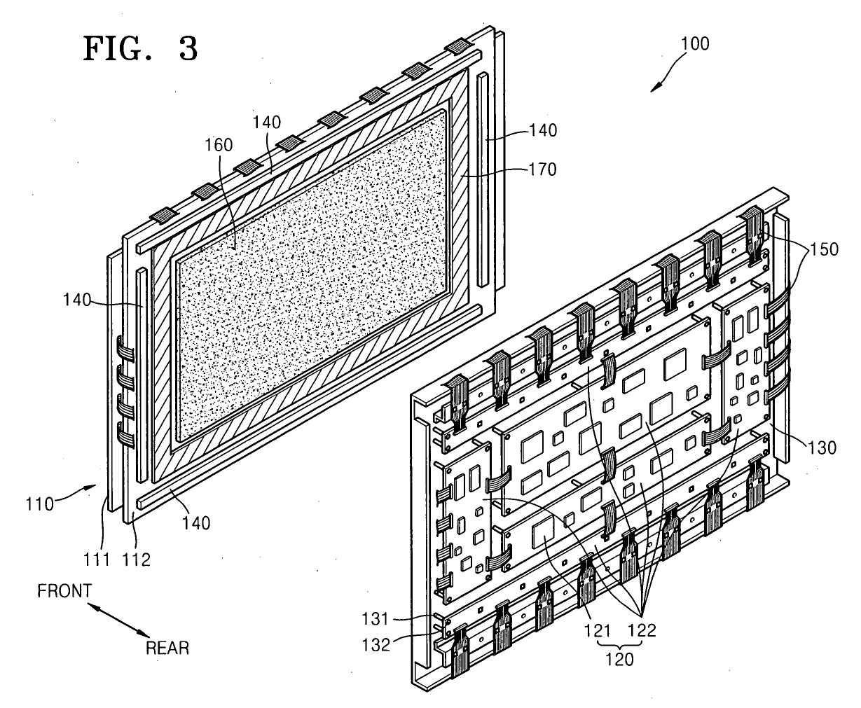

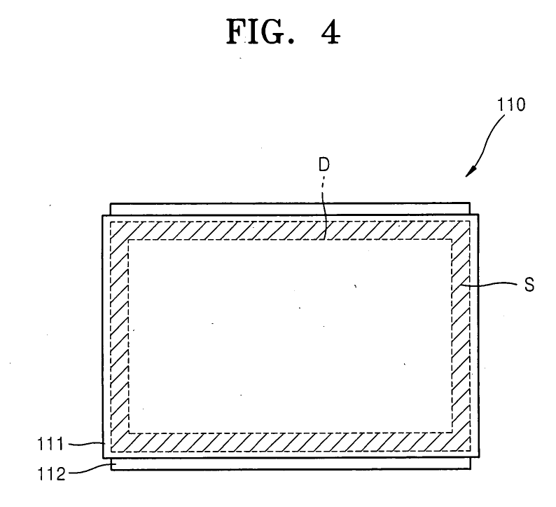

FIG. 3 is a schematic exploded perspective view of plasma display module 100 constructed as an embodiment of the present invention, and FIG. 4 is a front view of plasma display panel (PDP) 110 included in plasma display module 100 shown in FIG. 3, which is constructed as an embodiment of the present invention.

Plasma display module 100 of the current embodiment includes PDP 110, driving apparatus 120, and chassis 130. PDP 110, which displays images, has a first surface on one side and a second surface on the opposite side. The first surface of PDP 110 is substantially parallel to the second surface of PDP 110. PDP 110 includes first substrate 111 and second substrate 112. An inner surfaces of first substrate 111 faces an inner surface of second substrate 112. Therefore, an outer surface of first substrate 111 can be referred to as the first surface of PDP 110, and an outer surface of the second substrate can be referred to as the second surface of PDP 110.

Driving apparatus 120 includes a plurality of circuit elements 121, and a plurality of circuit boards 122 on which circuit elements 121 are disposed. In the present embodiment, circuit boards 122 are mounted on chassis 130 using a plurality of bosses 131 and a plurality of bolts 132.

Chassis 130 is made of a conductive material such as a steel material or an aluminum material. Chassis 130 of the current embodiment is made of steel or aluminum. The material of chassis 130 of the present invention, however, is not limited thereto. There is no specific limitations in selecting materials for chassis 130. In consideration of the total weight of plasma display module 100, chassis 130 may be made of aluminum or a synthetic resin that is lightweight and has high strength and rigidity.

PDP 110 and chassis 130 are coupled to each other using a plurality of double sided adhesive units 140 that are attached on the second surface of PDP 110 or an outer surface of second substrate 112. The double sided adhesive units 140 can be double sided adhesive tapes.

PDP 110 and circuit boards 122 are electrically connected to each other using a plurality of signal transmission units 150. Signal transmission units 150 can be, for example, flexible printed cables (FPCs) or tape carrier packages (TCPs).

Heat dissipation sheet 160 is interposed between PDP 110 and chassis 130. Heat dissipation sheet 160 includes graphite having superior thermal conductivity, and a front surface of heat dissipation sheet 160 adheres to the outer surface of second substrate 112. Heat dissipation sheet 160 of the current embodiment includes graphite. The material of heat dissipation sheet 160 of the present invention, however, is not limited thereto. Heat dissipation sheet 160 of the current embodiment can be made of any material as long as the material has a high thermal conductivity.

Referring to FIG. 4, a surface of PDP 110 can be divided into display area D and. non-display area S. Display area D displays images, while non-display area S does not display image. Non-display area S is located outside a periphery of display area D.

Vibration reduction unit 170 is disposed on a portion of the second surface of PDP 110 (the outer surface of second substrate 112). Vibration reduction unit 170 is disposed on non-display area S of PDP 110. In particular, vibration reduction unit 170 corresponds to the portion where a dummy barrier rib is formed inside PDP 110.

Vibration reduction unit 170 is formed by attaching a tape made of a silicon material having an adhesive surface onto the outer surface of second substrate 112 so as to absorb and remove noise and vibration generated on non-display area S of PDP 110.

Vibration reduction unit 170 is disposed to surround heat dissipation sheet 160 in order to correspond to non-display area S of PDP 110. Accordingly, the position of heat dissipation sheet 160 of the current embodiment is within display area D of PDP 110. Therefore, vibration reduction unit 170 surrounds heat dissipation sheet 160 so that vibration reduction unit 170 is located on non-display area S and surrounds display area D, and therefore the vibration and the noise generated from non-display area S can be absorbed by vibration reduction unit 170.

Vibration reduction unit 170 of the current embodiment is formed to have a thickness such that vibration reduction unit 170 does not contact chassis 130 after plasma display module 100 is assembled. The present invention, however, is not limited thereto. Vibration reduction unit 170 can have a thickness such that vibration reduction unit 170 contacts chassis 130, and thus, the vibration and noise generated from chassis 130 can be absorbed.

Vibration reduction unit 170 of the current embodiment includes an adhesive surface on one surface thereof so as to be attached to second substrate 112. The present invention, however, is not limited thereto. A first adhesive surface can be formed on one surface of vibration reduction unit 170, and a second adhesive surface can be formed on the opposite surface of vibration reduction unit 170, so that the first adhesive surface of the vibration reduction unit 170 can be attached to second substrate 112 and the second adhesive surface of vibration reduction unit 170 can be attached to chassis 130. In this case, vibration reduction unit 170 can function as a double sided adhesive unit 140 that couples PDP 110 to chassis 130, as well as reducing the vibration and noise.

Vibration reduction unit 170 of the current embodiment is disposed on the outer surface of second substrate 112. The present invention, however, is not limited thereto. Hence, vibration reduction unit 170 can be disposed on the outer surface of first substrate 111 (the first surface of PDP 110), and can be disposed on both the outer surfaces of first substrate 111 and second substrate 112 simultaneously.

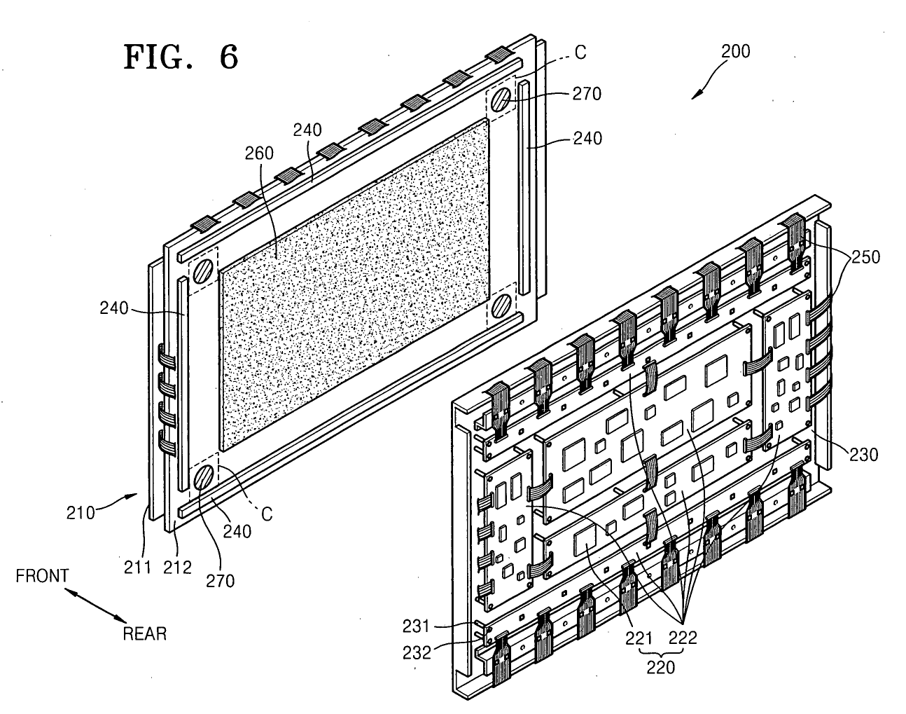

Vibration reduction unit 170 of the current embodiment is formed in a continuous shape, which can be referred to as a closed shape. When vibration reduction unit 170 is formed surrounding display area S as shown in FIG. 3, the closed shape means that a beginning portion of vibration reduction unit 170 is connected to an end portion of vibration reduction unit 170, and therefore, vibration reduction unit 170 has a shape of a closed loop that encloses display area S. The present invention, however, is not limited thereto. Vibration reduction unit 170 can be formed in an open shape. The open shape means that there are a beginning portion and an end portion of vibration reduction unit 170 that are not connected to each other. Therefore, vibration reduction unit 170 in an open shape is not formed into a shape of a closed loop, and may include multiple pieces of vibration reduction units. In this case, vibration reduction unit 170 of the present invention can have a plurality of sub-vibration reduction units, each of which can have an open shape or a closed shape. One example of vibration reduction unit 170 in an open shape is shown in FIG. 6, which will be described in detail later.

In addition, vibration reduction unit 170 of the current embodiment is formed in a continuous shape to surround heat dissipation sheet 160. The present invention, however, is not limited thereto. Vibration reduction unit 170 of the present invention can be formed to surround a part of heat dissipation sheet 160, or can be disposed on corners corresponding to non-display area S if vibration reduction unit 170 can be disposed on the portion corresponding to non-display area S of PDP 10.

Vibration reduction unit 170 of the current embodiment is formed as a tape having an adhesive surface. The present invention, however, is not limited thereto. Vibration reduction unit 170 of the present invention can be formed by applying a paste of a vibration reduction material, such as silicon, on PDP 110.

Vibration reduction unit 170 of the current embodiment is formed of silicon material, but there is no specific limitation in the materials for forming vibration reduction unit 170 as long as the material can absorb vibrations. For example, vibration reduction unit 170 can be formed of polyurethane, natural rubber, or synthetic rubber.

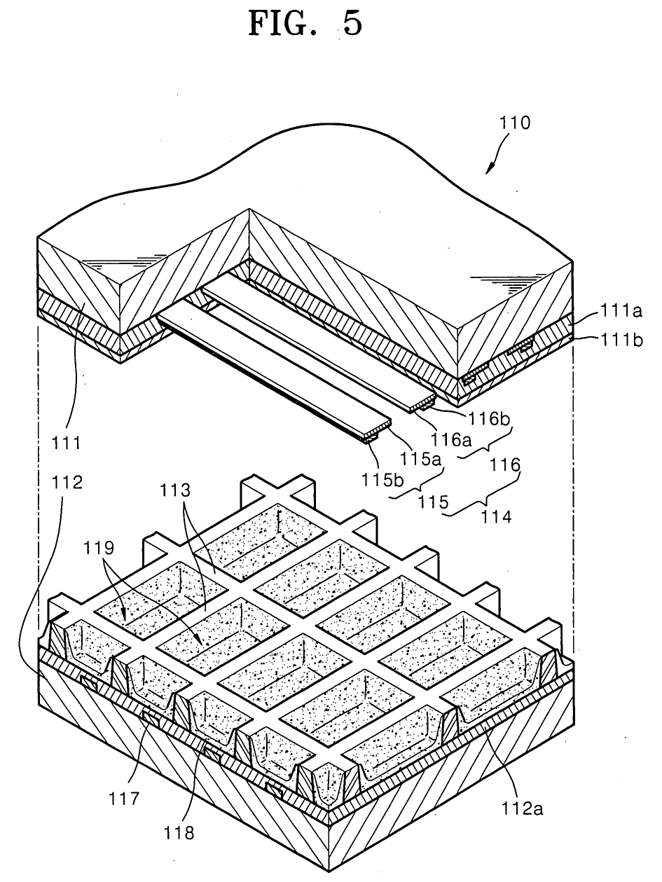

Hereinafter, an internal structure of display area D of PDP 110 will be described in detail with reference to FIG. 5.

FIG. 5 is a partially cut perspective view of display area D in PDP 110 that is included in the plasma display module shown in FIG. 3. Referring to FIG. 5, display area D of PDP 110 includes first substrate 111, second substrate 112, a plurality of barrier ribs 113, sustain electrodes 114, address electrodes 117, and phosphor layers 118.

First and second substrates 111 and 112 are separated by a predetermined distance from each other, and face each other. First substrate 111 is formed of a transparent glass material so that visible rays can be transmitted through first substrate 111. According to the current embodiment, because first substrate 111 is transparent, visible rays generated through discharge are transmitted through first substrate 111. The present invention, however, is not limited thereto. Both of first and second substrates 111 and 112 can be transparent. In addition, first and second substrates 111 and 112 can be made of a semi-transparent material, and can include a color filter on the surfaces thereof or in first and second substrates 111 and 112.

Barrier ribs 113 are disposed between first and second substrates 111 and 112. Barrier ribs 113 maintain discharge distances, define discharge spaces of a plurality of discharge cells 119 together with sustain electrodes 114 and address electrode 117. Barrier ribs 113 prevent electric and optical cross-talk between discharge cells 119.

A transverse cross section of discharge cells 119 that is defined by barrier ribs 113 is a square in the current embodiment. The present invention, however, is not limited thereto. The transverse cross section of discharge cell 119 can be formed as a polygon such as a pentagon, a circle, or an oval. Barrier ribs 113 can be formed as stripes.

Each of sustain electrodes 114 includes first electrode 115 and second electrode 116. One of first and second electrodes 115 and 116 performs as a common electrode, and the other of first and second electrodes 115 and 116 performs as a scan electrode. First and second electrodes 115 and 116 include transparent electrodes 115a and 116a, and bus electrodes 115b and 116b, respectively, which are formed as stripes. Transparent electrodes 115a and 116a are made of indium tin oxide (ITO) so that visible rays can be transmitted therethrough. Transparent electrodes 115a and 116a are disposed on an inner surface of first substrate 111.

Bus electrodes 115b and 116b are disposed on transparent electrodes 115a and 116a, and are formed of a metal material, such as silver (Ag), copper (Cu), or aluminum (Al) having high electric conductivity, with a narrow width in order to reduce line resistance of transparent electrodes 115a and 116a.

First and second electrodes 115 and 116 of the current embodiment include transparent electrodes 115a and 116a made of ITO. The present invention, however, is not limited thereto. First and second electrodes 115 and 116 of the present invention can include bus electrodes 115b and 116b that are formed of an opaque silver (Ag), copper (Cu), or aluminum (Al) material without transparent electrodes 115a and 116a. However, in this case, first and second electrodes 115 and 116 may be divided into several branches having narrow widths in order to improve a transmittance of visible rays.

In addition, first and second electrodes 115 and 116 are covered in first dielectric layer 111a. First dielectric layer 111a is formed on first substrate 111. First dielectric layer 111a prevents sustain electrodes 114 from directly electrically connected with each other during a sustain discharge, prevents charged particles from directly colliding with sustain electrodes 114, and induces the charged particles to accumulate as wall charges. In addition, first dielectric layer 111a can be formed of a dielectric material such as PbO, B₂O₃, or SiO₂.

Protective layer 111b is formed on a surface of first dielectric layer 111a, and protective layer 111b is formed of MgO. Protective layer 111b prevents sustain electrodes 114 from being damaged from sputtering of plasma particles, and discharges secondary electrons in order to decrease a discharge voltage.

Address electrodes 117 are disposed on second substrate 112 crossing sustain electrodes 114. Address electrodes 117 extend as stripes, and perform an address discharge with sustain electrodes 114 performing as scan electrodes disposed on first substrate 111.

Second dielectric layer 112a is formed on second substrate 112 to cover address electrodes 117 in second dielectric layer 112a. Second dielectric layer 112a protects address electrodes 117 and induces wall charges.

Phosphor layers 118 emitting blue, green, and red visible rays are formed on an inner surface of second dielectric layer 112a, which become bottom surfaces of discharge cells 119, and on side surfaces of barrier ribs 113. Phosphor layers 118 can be divided into blue phosphor layers, green phosphor layers, and red phosphor layers according to the colors of visible rays that are to be emitted, and the layers of each color are formed in a row. Pphosphor layer 118 has a function of receiving ultraviolet rays and emitting visible rays. Blue phosphor layer 118 is formed of BaMgAl₁₀O₁₇:Eu, green phosphor layer is formed of Zn₂SiO₄:Mn, and red phosphor layer is formed of Y(V,P)O₄:Eu.

After sealing first and second substrates 111 and 112 with each other using a frit, inner space of PDP 110 is initially filled with air. Air in PDP 110 is completely exhausted and an appropriate discharge gas is injected. A mixed gas of Ne—Xe, He—Xe, or He—Ne—Xe can be used as the discharge gas.

The operation of plasma display module 100 according to the current embodiment will be described in detail. After assembling PDP 110 and injecting the discharge gas into PDP 110, if a predetermined address voltage from an external power source is applied to address electrodes 117 and sustain electrodes 114 that function as the scan electrodes, an address discharge occurs. Some of discharge cells 119, in which a sustain discharge will occur, are selected as a result of the address discharge. If a sustain discharge voltage is applied to sustain electrodes 114 of selected discharge cells 119, wall charges move to generate the sustain discharge. An energy level of the excited discharge gas is reduced during the sustain discharge and the ultraviolet rays are emitted.

The ultraviolet rays excite phosphor layers 118 that are formed in discharge cells 119. The visible rays are emitted while the energy levels of excited phosphor layers 118 lowers. The visible rays exit first substrate 111 to display images that are recognized by a user.

According to plasma display module 100 of the current embodiment, vibration reduction unit 170 is disposed on the portion corresponding to non-display area S of PDP 110, and thus, the generation of vibration and noise from non-display area S can be absorbed and removed by vibration reduction unit 170.

Hereinafter, a plasma display module constructed as another embodiment of the present invention will be described with reference to FIG. 6, and different elements from those of the previous embodiment will be described.

FIG. 6 is a schematic exploded perspective view of plasma display module 200 constructed as another embodiment of the present invention. Plasma display module 200 of the current embodiment includes PDP 210 that includes first substrate 211 and second substrate 212, driving apparatus 220 including a plurality of circuit elements 221 and a plurality of circuit boards 222, chassis 230, a plurality of double sided adhesive units 240, a plurality of signal transmission units 250, heat dissipation sheet 260, and a plurality of vibration reduction units 270.

Plasma display module 200 of the current embodiment is different from plasma display module 100 of the previous embodiment in terms of shape and material of vibration reduction units 270. In plasma display module 100 of the previous embodiment, vibration reduction unit 170 is formed to surround heat dissipation sheet 160. In plasma display module 200 of the current embodiment, the vibration reduction units 270 are separately disposed on corners C of the outer surface of second substrate 212 (the second surface of PDP 210), which corresponds to the non-display area.

Vibration reduction units 270 are formed as a circle and disposed to correspond to the corners of the outermost barrier rib in PDP 210. Therefore, the vibration and noise caused by the protrusion the outermost barrier ribs that is generated during the baking process of the barrier ribs can be absorbed.

Vibration reduction units 270 are formed by applying a paste type vibration-reduction material such as a polyurethane or a binder resin, and hardening the applied paste.

According to plasma display module 200 having the above structure, vibration reduction units 270 are disposed to correspond to corners C, which mainly generate the vibration and noise in the non-display area, and thus, the vibration and noise from the non-display area can be removed, and manufacturing costs for installing vibration reduction units 270 can be reduced. Vibration reduction units 270, however, may be formed in a continuous shape to surround the display area in order to completely reduce noise of the PDP as described referring to plasma display module 100 in FIG. 3.

The structure, operations, and effects of the plasma display module of the current embodiment are the same as those of the previous embodiment, and thus, detailed descriptions for those are omitted.

As described above, according to the plasma display module of the present invention, the vibration reduction unit is disposed on at least a part corresponding to the non-display area in the PDP, and thus, the generating of noise during the driving of the PDP can be efficiently removed.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A plasma display module comprising:
a plasma display panel for displaying an image, the plasma display panel having a first surface and a second surface that is substantially parallel to the first surface, the plasma display panel having a display area for displaying the image and a non-display area that does not display the image;
a driving apparatus for driving the plasma display panel;
a chassis disposed between the second surface of the plasma display panel and the driving apparatus, the chassis being coupled to each of the plasma display panel and the driving apparatus; and
a vibration reduction unit disposed on the non-display area of the plasma display panel.

2. The plasma display module of claim 1, comprised of the driving apparatus including a plurality of circuit elements and a plurality of circuit boards on which the circuit elements are disposed.

3. The plasma display module of claim 1, comprised of the plasma display panel being coupled to the chassis through a double sided adhesive unit.

4. The plasma display module of claim 1, further comprising a heat dissipation sheet being disposed between the second surface of the plasma display panel and the chassis.

5. The plasma display module of claim 1, comprised of the vibration reduction unit disposed on the first surface of the plasma display panel.

6. The plasma display module of claim 1, comprised of the vibration reduction unit disposed on the second surface of the plasma display panel.

7. The plasma display module of claim 1, comprised of the vibration reduction unit having a closed shape.

8. The plasma display module of claim 1, comprised of the vibration reduction unit having an open shape.

9. The plasma display module of claim 1, comprised of the vibration reduction unit being formed to surround the display area of the plasma display panel.

10. The plasma display module of claim 1, comprised of the vibration reduction unit disposed at a corner of the plasma display panel.

11. The plasma display module of claim 1, comprised of the vibration reduction unit including a tape.

12. The plasma display module of claim 1, comprised of the vibration reduction unit having an adhesive surface.

13. The plasma display module of claim 1, comprised of the vibration reduction having a first adhesive surface and a second adhesive surface.

14. The plasma display module of claim 13, wherein the first adhesive surface of the vibration reduction unit is attached to the second surface of the plasma display panel, and the second adhesive surface of the vibration reduction unit is attached to the chassis.

15. The plasma display module of claim 1, comprised of the vibration reduction unit being formed by applying a vibration-reduction material having a paste form.

16. The plasma display module of claim 1, comprised of the vibration reduction unit contacting the chassis.

17. The plasma display module of claim 1, comprised of the vibration reduction unit being made of a material including silicon.

18. The plasma display module of claim 1, comprised of the vibration reduction unit being made of a material including polyurethane.
